(19) United States
(12) Patent Application Publication
(10) Pub. No.: US 2020/0207919 A1
(43) Pub. Date: Jul. 2, 2020

(54) CROSSLINKING OF HYDRIDOSILOXANES WITH SILICON (II) COMPOUNDS

(71) Applicant: WACKER CHEMIE AG, Munich (DE)

(72) Inventor: Elke FRITZ-LANGHALS, Ottobrunn (DE)

(73) Assignee: WACKER CHEMIE AG, Munich (DE)

(21) Appl. No.: 16/616,173

(22) PCT Filed: May 23, 2017
(86) PCT No.: PCT/EP2017/062426

§ 371 Date: Nov. 22, 2019

(51) Int. Cl. C08G 77/06; C08G 77/12

(52) U.S. Cl. CPC C08G 77/06; C08G 77/12

(57) ABSTRACT

Cationic silicon (II) compounds catalyze reaction of organosiloxanes bearing lateral Si—H functions to crosslink the polymers. Hydridosilanes may also be prepared by this reaction. The cationic silicon (II) compounds contain a silicon (II) moiety where silicon is π-bonded to a cyclopentadienyl anion.

### CROSS REFERENCE TO RELATED APPLICATIONS

This application is the U.S. National Phase of PCT Appln. No. PCT/EP2017/062426 filed May 23, 2017, the disclosure of which is incorporated in its entirety by reference herein.

### BACKGROUND OF THE INVENTION

### 1. Field of the Invention

The invention relates to the preparation of crosslinked polysiloxanes and hydridosilanes from hydridosiloxanes having lateral SiH functions in the presence of compounds that contain at least one cationic Si(II) moiety, and to the crosslinkable mixtures.

### 2. Description of the Related Art

The crosslinking of linear or branched polysiloxanes is usually carried out by means of a hydrosilylation reaction normally catalyzed by platinum complexes in which hydridosiloxanes are reacted with vinyl-substituted siloxanes. There is thus far no simpler crosslinking process that does not involve the use of a second functionalized component. Single-component systems can in principle be provided at lesser expense. A single-component system for the catalytic crosslinking of siloxanes is therefore of great industrial importance.

A single-component system for the catalytic crosslinking of siloxanes in the presence of the catalyst B(C₆F₅)₃ is described in US 2006/0211836 and in Macromolecules 2012, 45, 2654. A disadvantage of the method described therein is that the catalyst B(C₆F₅)₃ is consumed in the course of the reaction, with the formation of catalytically inactive compounds. This means there is a risk of the reaction ceasing prematurely. For a high turnover, it is therefore necessary to use relatively large amounts of catalyst, rendering the process considerably more costly. There is also the risk that the volatility of the decomposition products formed from the catalyst B(C₆F₅)₃ prevents them from being completely separated from the hydridosilanes that are formed, resulting in a decrease in the quality of the hydridosilanes.

### SUMMARY OF THE INVENTION

The invention relates to a process for preparing crosslinked polysiloxanes, in which (A) a hydridosiloxane having lateral SiH functions is converted in the presence of (B) compound which contains at least one cationic Si(II) moiety. The invention also relates to a crosslinkable mixture (M1) consisting of

(A) hydridosiloxanes having lateral SiH functions and

(B) compounds which contain at least one cationic Si(II) moiety, and to a crosslinkable mixture (M2) consisting of

(A) hydridosiloxanes having lateral SiH functions,

(B) compounds which contains at least one cationic Si(II) moiety, and

(C) additives which are unreactive toward A and B.

### DETAILED DESCRIPTION OF THE PREFERRED EMBODIMENTS

It was surprisingly found that polysiloxanes laterally functionalized with hydrido groups (SiH functions) react, in the presence of cationic Si(II) compounds as a catalyst, to form crosslinked polysiloxanes and hydridosilanes. The cationic silicon(II) compounds are stable under the reaction conditions. If conversion is incomplete, the polysiloxanes will still contain residual SiH functions.

Hydridosilanes are of industrial importance, particularly in the electronics industry. They are generally obtained by reduction of the corresponding chlorosilanes. This process is, however, technically laborious. A straightforward, reliable, and inexpensive process for preparing highly flammable and highly reactive hydridosilanes is therefore of major industrial importance too.

The process for preparing crosslinked polysiloxanes is carried out using only compounds A and B. In the process, preference is given to the presence only of compounds A and B alone (mixture M1) or together with additives C which are unreactive toward A and B (mixture M2).

Compound A preferably contains at least, two lateral SiH functions (hydrogen directly bonded to a silicon atom) per molecule. Compound A is preferably linear, branched or cyclic.

Compound A preferably has the general formula (I)

(SiO_{4/2})ₐ(R¹SiO_{3/2})_{b}(R²HSiO_{2/2})_{c}(R³₃SiO_{1/2})_{d} (I)

in which
R¹, R², and R³ independently represent hydrogen, halogen, unsubstituted or halogen-substituted hydrocarbon radicals or hydrocarbonoxy radicals, wherein individual carbon atoms may each be replaced by oxygen atoms, silicon atoms, sulfur or phosphorus atoms, and
a, b, c, and d each represent integral values, wherein a, b, and d can take values of 0 to 100,000, and c can take values of 2 to 100,000.

The radicals R¹, R², and R³ independently preferably represent hydrogen, chlorine, or unsubstituted or halogen-substituted, unbranched, branched, linear, acyclic or cyclic, saturated or monounsaturated or polyunsaturated C1-C20 hydrocarbon radicals or unsubstituted or halogen-substituted, unbranched, branched, linear or cyclic, saturated or monounsaturated or polyunsaturated C1-C20 hydrocarbonoxy radicals, wherein individual carbon atoms may be replaced by oxygen or halogen.

The oxygen atoms in the radicals R¹, R², and R³ are preferably nonadjacent.

Most preferably, the radicals R¹, R², and R³ independently represent hydrogen, C1-C3 alkyl radicals, phenyl radicals. C1-C4 alkoxy radicals or chlorine. Preferred C1-C3 alkyl radicals are methyl, ethyl, and n-propyl radicals. Preferred C1-C4 alkoxy radicals are methoxy, ethoxy, and n-propoxy radicals.

The radicals R₂ preferably represent either hydrogen or C1-C3 alkyl radicals or phenyl radicals.

a preferably represents values from 1 to 500, in particular 2 to 50.

b preferably represents values from 1 to 500, in particular 2 to 50.

c preferably represents values from 3 to 10,000, in particular 4 to 1000.

d preferably represents values from 1 to 100, in particular 2.

The sum a+b+c+d is preferably 4 to 20,000, more preferably 6 to 5000, in particular 10 to 500.

Examples of compounds (A) are the following hydridosiloxanes: SiMe₃-O-(MeHSiO)_{c}-SiMe₃ where c=10-100, SiMe₃-O-(MeHSiO)_{c1}-(Me₂SiO)_{c2}-SiMe₃ where c1=1-100 and c2=5-200.

Compound A may also be a mixture of different compounds of the general formula I.

The invention also relates to a process for preparing hydridosilanes in which (A) hydridosiloxane having lateral SiH functions are converted in the presence of (B) compounds which contain at least one cationic Si(II) moiety.

In addition to crosslinked silicone polymers, the process according to the invention results in the formation of hydridosilanes, preferably of the general formula II

R¹ₑR²_{f}R³_{g}SiHₕ (II)

wherein the radicals R¹, R², and R³ represent the definitions and preferred definitions above and e, f, g, and h each represent integral values from 0 to 3, wherein h is >0 and the sum of e, f, g, and h is 4.

Examples of hydridosilanes of the general formula (II) are methylsilane, dimethylsilane, trimethylsilane, and mixtures thereof.

Compounds B contain one or more cationic Si(II) moieties. Compounds B are silicon(II) compounds that are in cationic form—so-called silylium ylide cations.

Compound B preferably contains a cationic Si(II) compound of the general formula III

([Si(II)Cp]⁺)ᵢXⁱ⁻ (III)

where

Cp represents a π-bonded cyclopentadienyl moiety of the general formula IV that is substituted with the radicals R^{y}

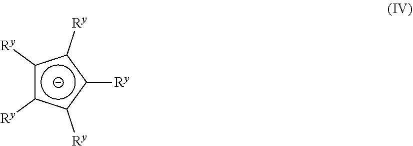

wherein

Cp represents the cyclopentadienyl anion which consists of a singly negatively charged, aromatic five-membered ring system C₅R^{y}₅⁻,

R^{y} independently represents a monovalent or polyvalent radical that may also be attached to other radicals R^{y} to form fused rings,

Xⁱ⁻ represents any i-valent anion which does not react with the cationic silicon(II) center under the conditions of a hydrosilylation reaction, and

i has the values 1, 2, 3, 4 or 5.

The radicals R^{y}, independently, preferably represent hydrogen, C1-C20 hydrocarbon radicals, more preferably linear or branched, acyclic or cyclic, saturated or mono- or polyunsaturated C1-C20 alkyl or aryl, most preferably C1-C3 alkyl, especially preferably methyl radicals.

Examples of radicals R^{y} are alkyl radicals such as the methyl, ethyl, n-propyl, isopropyl, n-butyl, sec-butyl, isobutyl, tert-butyl, n-pentyl, sec-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,4,4-trimethylpentyl radical; nonyl radicals such as the n-nonyl radical; decyl radicals such as the n-decyl radical; dodecyl radicals such as the n-dodecyl radical; hexadecyl radicals such as the n-hexadecyl radical; octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl, and phenanthryl radicals; alkaryl radicals such as the o-, m-, and p-tolyl, xylyl, mesitylenyl, and, o-, m-, and p-ethylphenyl radicals; and aralkyl radicals such as the benzyl radical, and the α- and β-phenylethyl radicals.

Further examples of compounds B are the following cationic Si(II) compounds:

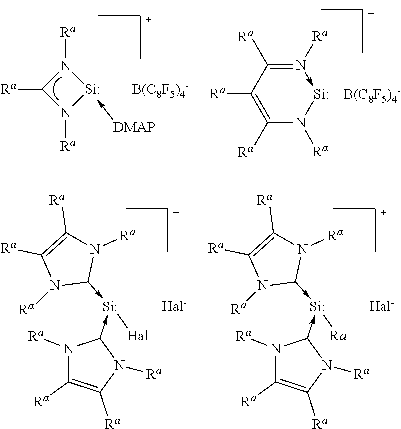

the preparations of which are described in So et. al., Chem. Eur. J. 2013, 19, 11786, Driess et al., Angew, Chem. Int. Ed. 2006, 45, 6730, Filippou, Angew. Chem. Int. Ed. 2013, 52, 6974, Sasamori et al., Chem. Eur. J. 2014, 20, 9246, and in Inoue et al., Chem. Commun. 2014, 50, 12619 (DMAP=dimethylaminopyridine).

In the formulae, the radicals R^{a}, independently, preferably represent alkyl or optionally substituted phenyl, more preferably branched alkyl or 2,6-dialkylated phenyl, and Hal represents halogen, preferably chlorine, bromine or iodine. Examples of radicals R^{a} are methyl, isopropyl, tert-butyl, 2,6-diisopropylphenyl or 2,4,6-triisopropylphenyl.

Xⁱ⁻ represents any i-valent anion which does not react with the cationic silicon(II) center under the conditions of a hydro-silylation reaction. It can be either inorganic or organic. i preferably has the values 1, 2, or 3, in particular 1.

X³¹ preferably represents halogen or a complex anion such as BF₄⁻, ClO₄⁻, AlZ₄⁻, MF₆⁻, where Z=halogen and M=P, As or Sb, or tetraarylborate anion, wherein the aryl radical is preferably phenyl or fluorinated phenyl or phenyl substituted with perfluoroalkyl radicals, monovalent polyhedral anion, for example carborate anion, or alkoxy- and aryloxymetalate ion.

Examples of anions X⁻ are tetrachlorometalates [MCl₄]⁻ where M=Al, Ga, tetrafluoroborates [BF₄]⁻, hexafluorometalates [MF₆]⁻ where M=As, Sb, Ir, Pt, perfluoroantimonates [Sb₂F₁₁]⁻, [Sb₃F₁₆]⁻ and [Sb₄F₂₁]⁻, triflate (=trifluoromethanesulfonate) [OSO₂CF₃]⁻, tetrakis(trifluoromethyl)borate [B(CF₂)₄]⁻, tetrakis(pentafluorophenyl)metalates [M(C₆F₅)₄]⁻ where M=B, Al, Ga, tetrakis(pentachlorophenyl)borate [B(C₆Cl₅)₄]⁻, tetrakis[(2,4,6-trifluoromethyl(phenyl)]borate {B[(C₆H₂(CF₃)₃]}⁻, [bis[tris(pentafluorophenyl)]hydroxide {HO[B(C₆F₅)₃]₂}⁻, closo-carborates [CHB₁₁H₅Cl₆⁻, [CHB₁₁H₅Br₆]⁻, [CHB₁₁(CH₃)₅Br₆]⁻, [CHB₁₁F₁₁]⁻, [C(Et)B₁₁F₁₁]⁻, [CB₁₁(CF₃)₁₂]⁻, and B₁₂Cl₁₁N(CH₃)₃]⁻, tetra(perfluoroalkoxy)aluminates [Al(OR^{PF})₄]⁻, tris(perfluoroalkoxy)fluoroaluminates [FAl(OR^{PF})₃]⁻, hexakis(oxypentafluorotelluro)antimonate [Sb(OTeF₅)₆]⁻.

An overview of especially preferred complex anions X⁻ is given, for example, in Krossing et_{—} al., Angew. Chem. 2004, 116, 2116.

The cationic Si(II) compound of the general formula (IV) may be prepared by addition of an acid H⁺X⁻ to the compound Si(II)Cp₂, which results in elimination of one of the anionic Cp moieties in protonated form:

Si(II)Cp₂+H⁺X⁻->Si(II)⁺CpX⁻+CpH

The anion X⁻ of the acid HX then forms the counterion of the cationic silicon(II) compound.

A method for preparing the cationic Si(II) compound of the general formula (II) is described in Science 2004, 305, pp. 849-851.

In the processes, compound A is converted in the presence of compound B as a crosslinking catalyst, producing both a crosslinked silicone polymer and hydridosilanes of the general formula II.

The molar proportion of the cationic silicon(II) compound B relative to the available Si—H moieties in compound A is preferably not less than 0.0001 mol % and not more than 10 mol %, more preferably not less than 0.001 mol % and not more than 1 mol %, most preferably not less than 0.01 mol % and not more than 0.1 mol %.

The compounds A and B may be mixed in any order, with mixing carried out in a manner known to those skilled in the art. In a further embodiment, compound B is generated in situ in compound A by a reaction, for example the protonation reaction described above.

The hydridosilanes of the general formula II that are formed may be separated from the reaction mixture in a manner known to those skilled in the art. Separation by distillation or by extraction is preferred. The purification of the resulting hydridosilanes is preferably carried out preferably by fractional distillation.

The conversion of compound A in the presence of compound B may be carried out in mixture M2 with or without addition of one or mere solvents. The proportion of the solvent or solvent mixture relative to compound A is preferably not less than 0.01% by weight and not more than 1000 times the weight, more preferably not less than 1% by weight and not more than 100 times the weight, most preferably not less than 10% by weight and not mere than 10 times the weight.

Solvents are preferably aprotic solvents, for example hydrocarbons such as pentane, hexane, heptane, cyclohexane or toluene, chlorinated hydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as acetonitrile or propionitrile.

Solvents or solvent mixtures with a boiling point/boiling range of up to 120° C. at 0.1 MPa are preferred.

The preferred solvents are aromatic or aliphatic hydrocarbons.

In a preferred embodiment, the cationic silicon(II) compound B is dissolved in a solvent and then mixed with compound A.

The reaction may be carried out at ambient pressure or under reduced or under elevated pressure.

The pressure is preferably not less than 0.01 bar and not more than 100 bar, more preferably not less than 0.1 bar and not more than 10 bar. Most preferably the reaction is carried out at ambient pressure.

The conversion of A in the presence of B is preferably carried out at to between not less than −100° C. and not more than +250° C., more preferably between not less than −20° C. and not more than 150° C., and most preferably between not less than 0° C. and not more than 100° C.

The mixture M2 may contain, as additives C that are unreactive toward components A and B, any desired further compounds, for example solvents, process auxiliaries, for example emulsifiers, fillers, for example colloidal silica or quartz, adhesion promoters, stabilizers, for example radical inhibitors, pigments, for example dyes or white pigments, for example chalk or titanium dioxide, plasticizers, organic polymers, heat stabilizers, inhibitors, biologically active substances, and polyorganosiloxanes that contain neither SiH functions nor carbon-carbon multiple bonds.

Examples of polyorganosiloxanes that contain neither SiH functions nor carbon-carbon multiple bonds are polyorganosiloxane oils such as polydimethylsiloxane oils (AK oils) and resinous polyorganosiloxanes.

The crosslinkable mixture (M2) preferably contains additives (C) that are unreactive toward components (A) and (B) with a content of 0.001 to 70% by weight, in particular with a content of 0.1 to 40% by weight.

The meanings of all abovementioned symbols in the abovementioned formulae are in each case independent of one another. The silicon atom is tetravalent in all formulae.

Unless otherwise stated in each case, all amounts and percentages shown are based on weight and all temperatures are 20° C.

### Example 1

All work operations are carried out under Ar.

In a pressure-resistant NMR tube, 207 mg of the hydridosiloxane Me₃Si-(MeHSiO)₅—SiMe₃ (0.060 mmol of polymer, 3.40 mmol of Si—H moieties) is mixed with 1.00 g of dideuterodichloromethane and treated with a solution of 2.7 mg (3.2 μmol, approximately 0.1 mol %) of (π-Me₅C₅)Si⁺B(C₆F₅)₄⁻ in 1.00 g of dideuterodichloromethane, and the tube is closed pressure-tight. After 2 h, trimethylsilane (δ=3.92 ppm, dz), monomethylsilane (δ=3.52 ppm, q), and hydridosiloxane moieties (δ=4.65-4.76 ppm, broad) are detected by ¹H-NMR spectroscopy. After 5 h, the mixture is a gel-like solid. After restoring the tube to standard pressure, the silanes escape in gaseous form together with some of the dichloromethane, with the formation of a solid residue of the cross linked silicone polymer.

### Example 2

All work operations are carried out under Ar.

In a pressure-resistant NMR tube, 206 mg of the hydridosiloxane Me₃Si-(MeHSiO)₉-(Me₂SiO)₂₂—SiMe₃ (0.088 mmol of polymer, 0.79 mmol of Si—H moieties) is mixed with 1.00 g of dideuterodichloromethane and treated with a solution of 0.80 mg (0.95 μmol, approximately 0.1 mol %) of (π-Me₅C₅)Si⁺B(C₆F₅)₄⁻ in 1.00 g of dideuterodichloromethane, and the tube is closed pressure-tight. After 5 h, trimethylsilane (δ=3.92 ppm, dz), dimethylsilane (δ=3.76 ppm, sept.), monomethylsilane (δ=3.52 ppm, q), and hydridosiloxane moieties (δ=4.4-4.5 ppm, broad) are detected by H-NMR spectroscopy. After 24 h, the mixture is a gel-like solid.

1.-12. (canceled)

13. A process for preparing crosslinked polysiloxanes, comprising reacting (A) at least one hydridosiloxane having lateral SiH functions in the presence of (B) at least one compound which contains at least one cationic Si(II) moiety, to form A crosslinked polysiloxane, and/or one or more hydridosilanes.

14. The process of claim 13, wherein at least one hydridosilane is formed.

15. The process of claim 13, wherein at least one compound (A) has the formula (I)
(SiO_{4/2})ₐ(R¹SiO_{3/2})_{b}(R²HSiO_{2/2})_{c}(R³₃SiO_{1/2})_{d} (I)
in which
R¹, R², and R₃ independently represent hydrogen, halogen, unsubstituted or halogen-substituted hydrocarbon radicals or hydrocarbonoxy radicals, wherein individual carbon atoms are optionally replaced by oxygen atoms, silicon atoms, sulfur or phosphorus atoms, and
a, b, c, and d each represent integral values, wherein a, b, and d can take values of 0 to 100,000 and c can take values of 2 to 100,000.

16. The process of claim 15, wherein the radicals R¹, R², and R³ independently represent hydrogen, C1-C3 alkyl radicals, phenyl radicals, C1-C4 alkoxy radicals or chlorine.

17. The process of claim 15, wherein the sum a+b+c+d is from 4 to 20,000.

18. The process of claim 13, wherein at least one compound (B) is a cationic Si(II) compound of the formula (III)
([Si(II)Cp]⁺)ᵢXⁱ⁻ (III)
in which
Cp represents a π-bonded cyclopentadienyl anion which consists of a singly negatively charged, aromatic five-membered ring system C₅R^{y}₅⁻, 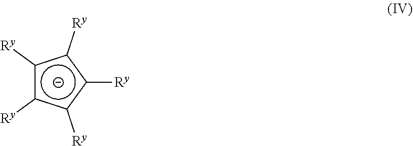
R^{y} independently represents a monovalent or polyvalent radical, optionally attached to other radicals R^{y} to form fused rings,
Xⁱ⁻ represents an i-valent anion which does not react with the cationic silicon(II) center under the conditions of a hydrosilylation reaction, and
i has the values 1, 2, 3, 4 or 5.

19. The process of claim 18, wherein the radicals R^{y} independently represent hydrogen or C1-C20 hydrocarbon radicals.

20. The process of claim 18, wherein at least one Xⁱ⁻ is BF₄⁻, ClO₄⁻, AlZ₄⁻, MF₆⁻ where Z=halogen and M=P, As or Sb, or tetraarylborate anion, monovalent polyhedral anion, alkoxy- or aryloxy-metalate ion, tetrachlorometalates [MCl₄]⁻ where M=Al, Ga, tetrafluoroborates [BF₄]⁻, hexafluorometalates [MF₆]⁻ where M=As, Sb, Ir, Pt, perfluoroantimonates [Sb₂F₁₁]⁻, [Sb₃F₁₆]⁻ and [Sb₄F₂₁]⁻, triflate, [OSO₂CF₃]⁻, tetrakis(trifluoromethyl)borate [B(CF₃)₄]⁻, tetrakis(pentafluorophenyl)metalates [M(C₆F₅)₄]⁻ where M=B, Al, Ga, tetrakis(pentachlorophenyl)borate [B(C₆Cl₅)₄]⁻, tetrakis[(2,4,6-trifluoromethyl(phenyl)]borate {B[C₆H₂(CF₃)₃]}⁻, [bis[tris(pentafluorophenyl)]hydroxide {HO[B(C₆F₅)₃]₂}⁻, closo-carbolates [CHB₁₁-H₅Cl₆]⁻, [CHB₁₁H₅Br₆]⁻, [CHB₁₁(CH₃)₅Br₆]⁻, [CHB₁₁F₁₁]³¹ , [C(Et)B₁₁F₁₁]⁻, [CB₁₁(CF₃)₁₂]⁻ or [B₁₂Cl₁₁N(CH₃)₃]⁻, tetra(perfluoroalkoxy)aluminate [Al(OR^{PF})₄]⁻, tris(perfluoroalkoxy)fluoroaluminate [FAl(OR^{PF})₃]⁻ or hexakis(oxypentafluorotelluro)antimonate [Sb(OTeF₅)₆]⁻.

21. The process of claim 14, wherein the hydridosilanes include one or more of methylsilane, dimethylsilane, and/or trimethylsilane.

22. A crosslinkable mixture comprising:
(A) at least one hydridosiloxane having lateral SiH functions,
(B) at least one compound which contains at least one cationic Si(II) moiety, and optionally,
(C) one or more additives which are unreactive toward (A) and (B).

23. The crosslinkable mixture of claim 22, wherein
(C) one or more additives which are unreactive toward A and B, are present.

24. The process of claim 22, wherein at least one compound (A) has the formula (I)
(SiO_{4/2})ₐ(R¹SiO_{3/2})_{b}(R²HSiO_{2/2})_{c}(R³₃SiO_{1/2})_{d} (I)
in which
R¹, R², and R³ independently represent hydrogen, halogen, unsubstituted or halogen-substituted hydrocarbon radicals or hydrocarbonoxy radicals, wherein individual carbon atoms are optionally replaced by oxygen atoms, silicon atoms, sulfur or phosphorus atoms, and
a, b, c, and d each represent integral values, wherein a, b, and d can take values of 0 to 100,000, and c can take values of 2 to 100,000.

25. The process of claim 24, wherein the radicals R¹, R², and R³ independently represent hydrogen, C1-C3 alkyl radicals, phenyl radicals, C1-C4 alkoxy radicals or chlorine.

26. The process of claim 24, wherein the sum a+b+c+d is from 4 to 20,000.

27. The process of claim 16, wherein at least one compound B is a cationic Si(II) compound of the formula (III)
([Si(II)Cp]⁺)ᵢXⁱ⁻ (III)
in which
Cp represents the π-bonded cyclopentadienyl anion which consists of a singly negatively charged, aromatic five-membered ring system C₅R^{y}₅⁻, 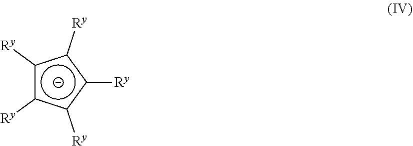
R^{y} independently represents a monovalent or polyvalent radical, optionally attached to other radicals R^{y} to form fused rings,
Xⁱ⁻ represents an i-valent anion which does not react with the cationic silicon(II) center under the conditions of a hydrosilylation reaction, and
i has the values 1, 2, 3, 4 or 5.

28. The process of claim 27, wherein the radicals R^{y} independently represent hydrogen or C1-C20 hydrocarbon radicals.

29. The process of claim 24, wherein at least one Xⁱ⁻ is BF₄⁻, ClO₄⁻, AlZ₄⁻, MF₆⁻ where Z=halogen and M=P, As or Sb, or tetraarylborate anion, monovalent polyhedral anion, alkoxy- or aryloxy-metalate ion, tetrachlorometalates [MCl₄]⁻ where M=Al, Ga, tetrafluoroborates [BF₄]⁻, hexafluorometalates [MF₆]⁻ where M=As, Sb, Ir, Pt, perfluoroantimonates [Sb₂F₁₁]⁻, [Sb₃F₁₆]⁻ and [Sb₄F₂₁]⁻, triflate, [OSO₂CF₃]⁻, tetrakis(trifluoromethyl)borate [B(CF₃)₄]⁻, tetrakis(pentafluorophenyl)metalates [M(C₆F₅)₄]⁻ where M=B, Al, Ga, tetrakis(pentachlorophenyl)borate [B(C₆Cl₅)₄]⁻, tetrakis[(2,4,6-trifluoromethyl(phenyl)]borate {B[C₆H₂(CF₃)₃]}⁻, [bis[tris(pentafluorophenyl)]hydroxide {HO[B(C₆F₅)₃]₂}⁻, closo-carbolates [CHB₁₁-H₅Cl₆]⁻, [CHB₁₁H₅Br₆]⁻, [CHB₁₁(CH₃)₅Br₆]⁻, [CHB₁₁F₁₁]³¹ , [C(Et)B₁₁F₁₁]⁻, [CB₁₁(CF₃)₁₂]⁻ or [B₁₂Cl₁₁N(CH₃)₃]⁻, tetra(perfluoroalkoxy)aluminate [Al(OR^{PF})₄]⁻, tris(perfluoroalkoxy)fluoroaluminate [FAl(OR^{PF})₃]⁻ or hexakis(oxypentafluorotelluro)antimonate [Sb(OTeF₅)₆]⁻.

30. The crosslinkable mixture of claim 22, wherein at least one additive C is present which is selected from the group consisting of solvents, process auxiliaries, fillers, adhesion promoters, stabilizers, pigments, plasticizers, organic polymers, heat stabilizers, inhibitors, biologically active substances, polyorganosiloxanes that contain neither SiH functions nor carbon-carbon multiple bonds, and mixtures thereof.
